(19) United States
(12) Patent Application Publication
(10) Pub. No.: US 2016/0236387 A1
(43) Pub. Date: Aug. 18, 2016

(54) RFID ENABLED CONTAINER

(71) Applicant: PARKER-HANNIFIN CORPORATION, Cleveland, OH (US)

(72) Inventors: Derek Alan Carroll, Los Angeles, CA (US); Gino G. Banco, Lyndhurst, OH (US)

(21) Appl. No.: 15/024,385

(22) PCT Filed: Nov. 17, 2014
(86) PCT No.: PCT/US2014/065938

§ 371 Date: Mar. 24, 2016

Related U.S. Application Data
(60) Provisional application No. 61/904,744, filed on Nov. 15, 2013.

(51) Int. Cl. B29C 45/16; G06K 19/077; B65D 25/20; B29C 45/14; B29D 22/00

(52) U.S. Cl. CPC B29C 45/1671; B29C 45/14639; B29D 22/003; B65D 25/205; G06K 19/07758; B29C 2045/1673; B29K 2105/0085

(57) ABSTRACT

A radio frequency identification (RFID)-enabled article includes a body formed of a plastic or other polymeric first material having at least one wall, the wall having a length, a width, and a thickness, and wherein the thickness dimension is smaller than the length and the width and is defined between a first surface and a second surface; and an RFID transponder embedded 5-95% into the thickness dimension of the wall. The first and second surfaces of the wall are free from witness marks.

### RELATED APPLICATIONS

This application claims the benefit of U.S. Provisional Application No. 61/904,744 filed Nov. 15, 2013, which is hereby incorporated herein by reference.

### FIELD OF INVENTION

The present invention relates generally to the process of embedding RFID tags within polymers, and more particularly to the use of injection molding to overmold RFID-embedded polymeric components.

### BACKGROUND

Radio-frequency identification (RFID) is the wireless use of radio-frequency electromagnetic fields to transfer data, often used to automatically identify and/or track objects via RFID devices attached to or otherwise associated with the objects. The RFID devices may contain electronically stored information. Some devices are powered by and read at short ranges (a few centimeters to a few meters) via magnetic fields (electromagnetic induction). These devices typically have no battery. Rather, they collect energy from the interrogating electromagnetic field. Other devices may use one or more local power sources such as a battery and then act as a transponder to emit radio waves. Battery powered tags may operate at up to hundreds of meters. RFID tags may be included in seals as described in U.S. Pat. No. 8,282,013, incorporated by reference herein in its entirety.

One means of integrating RFID into injection molded parts has been to use the in-mold decorating technique. This technique allows RFID which are adhered to a thin film to be incorporated into an injection molded part. This technique requires holding the film in place using vacuum channels in the mold before injection of the molten plastic. In-mold decorating is also commonly used for incorporating labels into an injection molded part.

Injection molding often utilizes a ram or screw-type plunger to force melted polymer into a cavity of a mold (molds can include a single cavity or multiple cavities). The polymer solidifies into a shape conforming to the mold cavity. In multiple cavity molds, each cavity can be identical (to form the same parts) or can be unique (to form different geometries during a single cycle). Molds may be made of any suitable material, but are generally made from tool steels. Stainless steels and aluminum molds are suitable for certain applications. Although it wears faster, aluminum may be cost effective in low volume applications because mold fabrication costs and time can be considerably lower.

Pelletized raw thermoplastics, one type of polymer, may be fed through a hopper into a heated chamber with a reciprocating screw. The temperature increases and the Van der Waals forces that resist relative flow of individual chains in the material are weakened as a result of increased space between molecules. This reduces the material's viscosity, enabling the polymer to flow and be driven by the injection unit.

The reciprocating screw may deliver the raw material forward, mixing the polymer and reducing the required heating time by mechanically shearing the polymer and adding a significant amount of frictional heat. The material may be fed through a check valve and may collect at the front of the reciprocating screw into a volume known as a shot. The amount of material in a shot typically is sufficient to fill the mold cavity, compensate for shrinkage, and provide a cushion (approximately 10% of the total shot volume may remain in the chamber to prevent the screw from bottoming out) to transfer pressure from the screw to the mold cavity.

When enough material has gathered, the material may be forced at high pressure and velocity into the mold cavity. Injection times are usually quite quick, often well under 1 second. Packing pressure is applied to complete mold filling and compensate for thermal shrinkage. The packing pressure may be applied until the cavity entrance solidifies.

Next, the screw reciprocates and acquires material for the next cycle while the material within the mold cools, solidifying enough to be ejected. Cooling lines circulating fluid may reduce the required cooling time. Once cooled, the mold opens and an array of pins, sleeves, strippers, etc. may be driven forward to extract the molded element. Then, the mold closes and the process may be repeated.

### SUMMARY OF INVENTION

Described herein and shown in the figures is an article such as a container (e.g., a medical/cryogenic vial) with an embedded RFID transponder (chip or tag). Embedding an RFID transponder within an article allows identification and/or tracking of the article (or contents therein) in a wireless manner that does not require any additional components or attachments to the container. The transponder does not interfere with the contents of the container in any way since it is completely embedded in the wall of the container. Exemplary methods have the additional benefits of not altering the form factor of the container and providing a means of protecting the transponder from being destroyed. Exemplary methods also do not rely on adhesives for attachment to the container. These adhesives can be affected by extreme temperatures and will allow the tag to detach from the vial.

In exemplary methods the RFID transponder is incorporated in the molded part without the appearance of witness marks and without the use of any film or requirements for vacuum channels to hold the film in place. Another advantage over the existing technique is that the RFID tag will be completely encapsulated in the injection molded material instead of placed between a thin layer of film on the surface of the part and the injection molded material.

Therefore, according to one aspect of the invention, a radio frequency identification (RFID)-enabled article includes a body formed of a plastic or other polymeric first material having at least one wall, the wall having a length, a width, and a thickness, and wherein the thickness dimension is smaller than the length and the width and is defined between a first surface and a second surface; and an RFID transponder embedded 5-95% into the thickness dimension of the wall. The first and second surfaces of the wall are free from witness marks.

Optionally, the RFID transponder is disposed in the wall and has a length, a width, and a thickness, and wherein the thickness of the RFID transponder is smaller than the length and width of the RFID transponder, and therein the RFID transponder is disposed such that the thickness of the RFID transponder is parallel to the thickness dimension of the wall.

Optionally, the RFID transponder is covered by a layer formed of a plastic or other polymeric second material which may the same as or different from the first material.

Optionally, the first surface comprises an exterior surface of the article.

Optionally, the second surface comprises an interior surface of the article.

Optionally, the wall is a side wall surrounding an inner cavity of the article.

Optionally, the article is a container.

Optionally, the article is a cryogenic vial.

Optionally, the article is the housing or wall of a device.

Optionally, the RFID transponder may be in the form of a chip or tag.

Optionally, the RFID transponder may be a 1D or 2D barcode, with or without transponding capabilities.

Optionally, the RFID transponder is embedded approximately 50% into the thickness dimension of the wall.

According to another aspect of the invention, a method of making a radio frequency identification (RFID)-enabled article includes the steps of: forming a body of a plastic or other polymeric first material having at least one wall, the wall having a preassembly thickness in a thickness dimension defined between a first surface and a second surface; placing an RFID transponder on the second surface of the wall; and encapsulating the RFID transponder by overmolding a plastic or other polymeric second material which may the same as or different from the first material onto the second surface and the RFID transponder, forming a monolithic wall having a new thickness dimension defined between the first surface and a new second surface, the new thickness being thicker than the preassembly thickness.

Optionally, forming the body step includes injection molding the plastic or other polymeric first material.

Optionally, the body step includes decreasing an initial thickness to the preassembly thickness by machining the second surface of the wall.

Optionally, the body step includes injection molding the plastic or other polymeric first material into a first cavity having a cavity geometry, and wherein the encapsulating step includes injection molding the plastic or other polymeric second material into the first cavity or a second cavity having the same cavity geometry as the first cavity.

Optionally, the method further includes expanding the body by heating before the encapsulating step.

Optionally, the new second surface comprises an exterior surface of the article.

Optionally, the forming the body step includes injection molding the plastic or other polymeric first material into a first cavity having a cavity geometry, and wherein the encapsulating step includes injection molding the plastic or other polymeric second material into a second cavity having a cavity geometry larger than the cavity geometry of the first cavity.

Optionally, the step of encapsulating the RFID transponder includes dip coating the body.

According to another aspect of the invention, an article is formed according to the method described above including any of the optionally described features.

According to another aspect, a method of making radio frequency identification (RFID)-enabled articles includes the steps of: closing a mold having a first cavity with a first geometry and a second cavity with a second geometry, the first cavity closing around a first mold core; injecting into the first cavity a plastic or other polymeric first material to form a first body having at least one wall; opening the mold to expose the first body; placing an RFID transponder on a surface of the wall; repositioning the first body and first core with respect to the mold; closing the mold with the first cavity around a second core and the second cavity around the first core; and simultaneously injecting into the first cavity a plastic or other polymeric second material, which may be the same as or different from the first material, to form a second body having at least one wall, and injecting into the second cavity a plastic or other polymeric third material, which may be the same as or different from the first and/or second material, to encapsulate the RFID transponder by overmolding the third material onto the second surface and the RFID transponder. The second geometry is larger than the first geometry.

According to another aspect of the invention, an article is made by the methods described above.

The foregoing and other features of the invention are hereinafter described in greater detail with reference to the accompanying drawings.

### BRIEF DESCRIPTION OF THE DRAWINGS

FIG. 1 is a perspective view of an exemplary RFID-enabled container;

FIG. 2 is a side view of the exemplary RFID-enabled container;

FIG. 3 is a top view of the exemplary RFID-enabled container;

FIG. 4 is a cross-sectional view of the exemplary RFID-enabled container taken through the RFID transponder;

FIG. 5 is a perspective view of an exemplary mold for making exemplary RFID-enabled articles;

FIG. 6 is a partial cross-sectional view of an empty exemplary mold cavity for making RFID-enabled articles;

FIG. 7 is a partial cross-sectional view of the exemplary mold cavity for making RFID-enabled articles after injection of material;

FIG. 8 is a partial cross-sectional view of the exemplary mold cavity for making RFID-enabled articles after machining of material and placement of the RFID transponder;

FIG. 9 is a partial cross-sectional view of the exemplary mold cavity for making RFID-enabled articles after injection of the second material; and

FIG. 10 is a partial cross-sectional view of an exemplary second mold cavity for making RFID-enabled articles after placement of the RFID transponder.

### DETAILED DESCRIPTION

Conventional RFID-enabled articles, especially those having thin walls with which the RFID transponder is associated, are made using either an in-mold decorating process or a plug-filling process.

In an in-mold decorating process, an RFID transponder may be adhesively attached to the surface of the article. This RFID tag may be covered by a thin layer of adhesive or other material. However, this process has disadvantages. First, it necessitates introduction of another material (such as the substrate holding the transponder and/or a covering lacquer) yielding a weaker bond. Second, the depth of the RFID transponder is typically only about 0.125 mm to 0.375 mm which amounts to less than 5% of the depth into the article (depending on wall thickness), yielding a less-protected transponder.

In a plug-filling process, a cavity in the article is made with the transponder being inserted into the cavity. A plug is adhesively coupled to the article to fill the cavity. However, this process may introduce a new material yielding a weaker bond, and will always leave witness marks, marring the surface of the article. A witness mark, as used herein, is an intentional, accidental, or naturally occurring visible or tactile sign spot, line, groove, or other contrasting area that serves as an indicator of an original surface on the article. So, for example, the plug-filling process leaves behind a visible line along the edges of the cavity even after the cavity is filled with the plug.

Exemplary processes incorporate the transponder into the molded part without the appearance of witness marks and without the use of any film or requirements for vacuum channels to hold the film in place. Another advantage over the existing technique is that the RFID tag will be completely encapsulated in the injection molded material instead of placed between a thin layer of film on the surface of the part and the injection molded material.

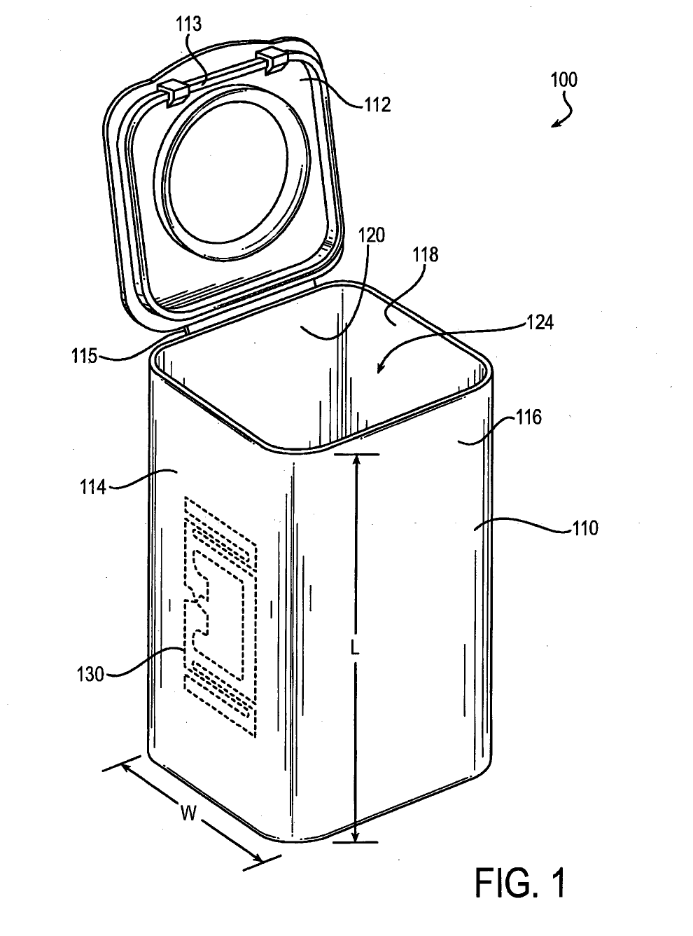

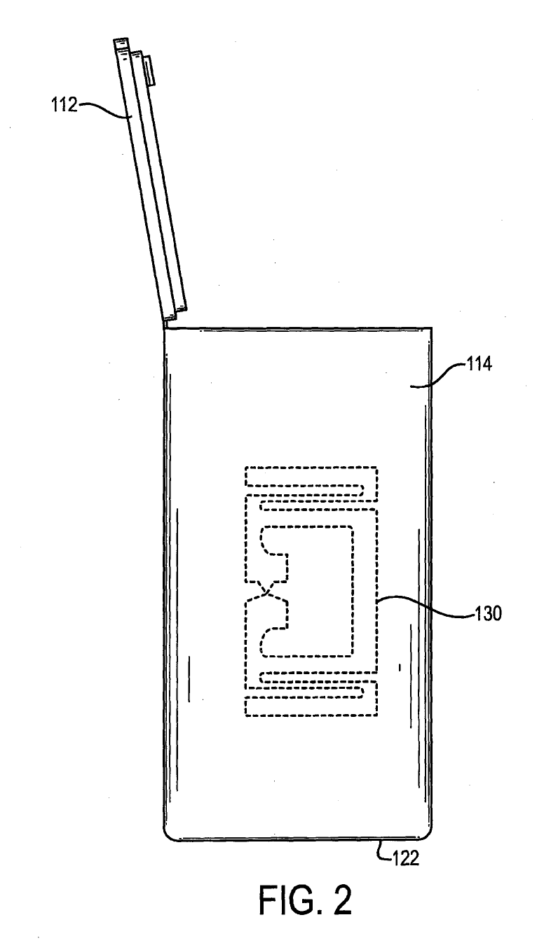

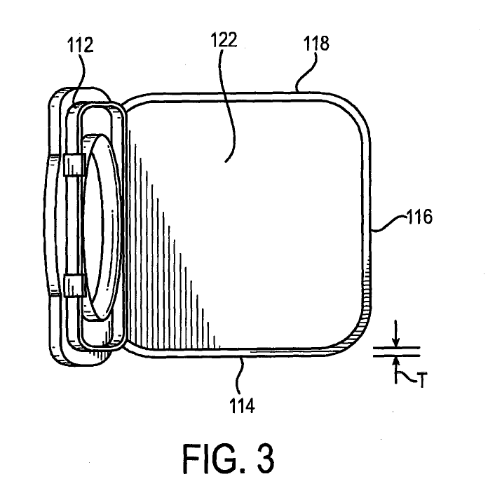

Referring now to FIGS. 1-4, shown are several views of an exemplary cryogenic medical container 100. The container 100 includes a body 110 formed of a plastic or other polymeric material. The body may be injection-molded as described herein. The body may include six walls. It will be understood that any molded part may be made by the disclosed processes, and a cryogenic medical container is merely one example thereof. Other examples include non-medical containers, vials, plastic machine parts, housings, etc. Similarly, although described herein as a method of embedding an RFID tag, other identifiers may also be embedded. For example, a 1D or 2D barcode may be embedded in a translucent material and may be visible to a barcode scanner.

The top wall 112 is configured as a lid and may be made separately from the rest of the body or may be manufactured integral with the rest of the body. The lid 112 is openable/closeable with respect to the container 100 and may be pivotably mounted on one of the side walls 114, 116, 118, 120 by a hinge, a thinned connection portion, or other attachment means 115. Optionally, the lid and/or one or more of the side walls includes a latch mechanism 113 configured to hold the lid in a closed position unless unlatched or acted upon by a sufficiently large force to overcome the latch force. Alternatively, the lid 112 may be completely removable from the rest of the container 112. As another alternative, the container may include no lid at all.

The container also includes a bottom 122. The bottom 122 forms with the sidewalls 114, 116, 118, 120 a central cavity 124 for holding material.

The RFID transponder 130 may be embedded in any of the walls of the container. The wall in which the transponder is embedded has a length, L, a width, W, and a thickness, T. For convenience, the thickness dimension T is defined herein as smaller than the length and the width and is defined between an inner surface 126 and an outer surface 128 of the wall, whereas the length and width extend between opposite edges of the wall. The transponder has a corresponding length, width, and thickness such that the thickness of the RFID transponder is parallel to the thickness dimension of the wall. The thickness of the RFID transponder is smaller than the length and width of the RFID transponder, and the thickness of the transponder is smaller than the thickness of the wall in which it is embedded.

Preferably, the thickness of the wall is less than 0.25 inches. More preferably, the thickness of the wall is less than 0.0625 inches. Still more preferably, the thickness of the wall is less than 0.008 inches. Even more preferably, the thickness of the wall is between about 0.0035 inches and 0.0040 inches. However, the thickness of the wall may also depend upon the particular material used to form the wall.

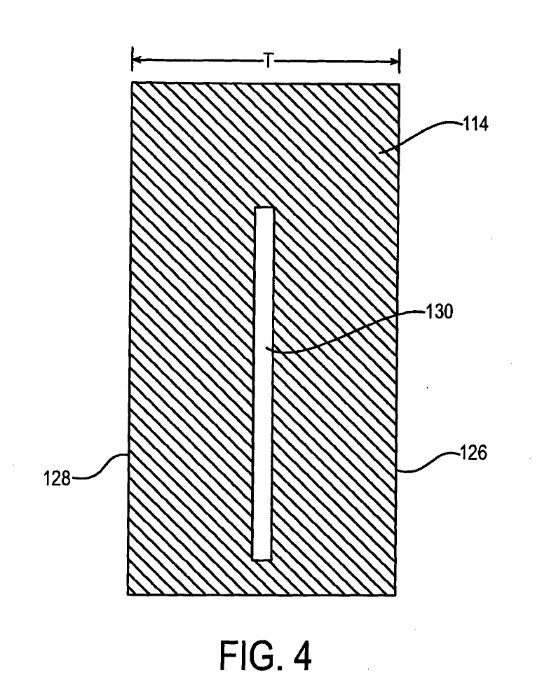

The transponder is embedded in the thickness of the wall, and is embedded further than the superficially deep in-mold decorating technique. Preferably, therefore, the RFID transponder is embedded between 5% and 95% into the thickness dimension of the wall. More preferably, the transponder is embedded about halfway into the wall as illustrated in FIG. 4. As mentioned, the outer and inner surfaces of the wall are free from witness marks caused by the embedding of the transponder.

As will be explained further below, the wall may include a first plastic or polymeric material and may be overmolded by a second plastic or polymeric material. These materials may be the same or different although preferably they are the same so as to maximize bonding between the material. Example materials include but are not limited to thermoplastics and other polymers such as, for example, cycloelefin copolymer (“COO”), a blend thereof, or a blend thereof.

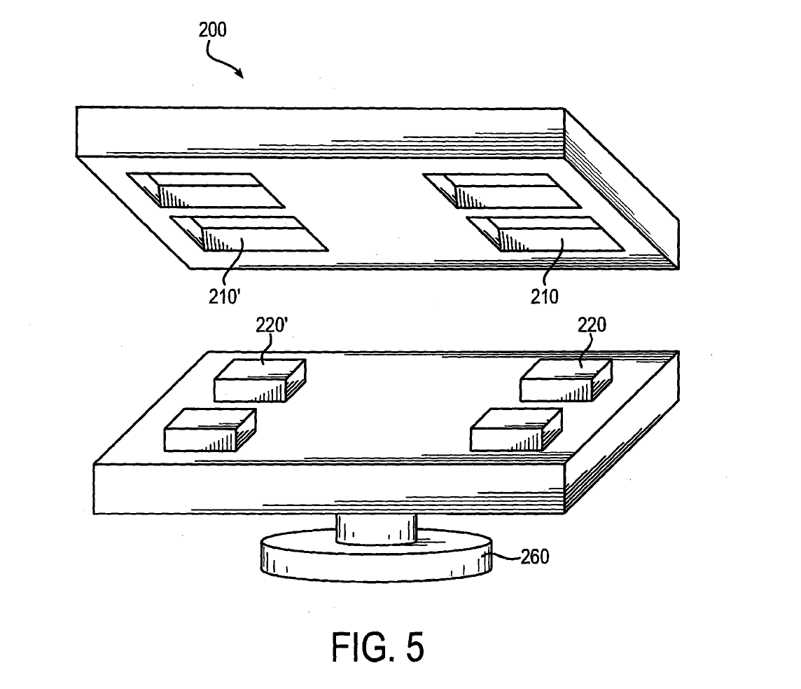

Turning now to FIGS. 5-10, shown are example mold apparatuses for making exemplary RFID-enabled articles.

Three example processes are detailed herein for clarity, but other processes and variations therein will be understood by those skilled in the art to be encompassed by this disclosure upon reading and understanding the disclosure.

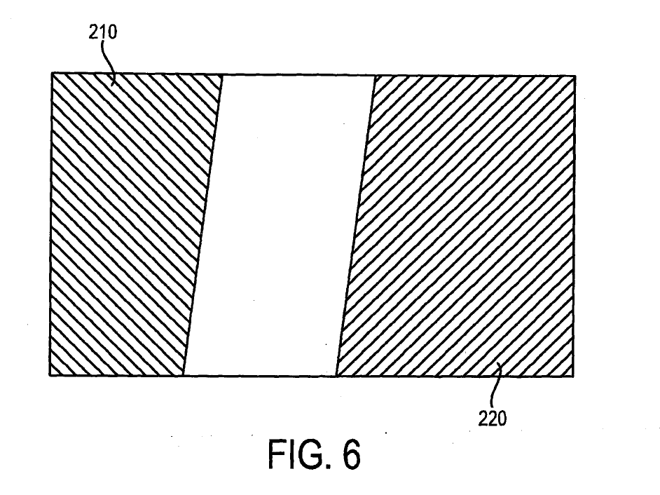

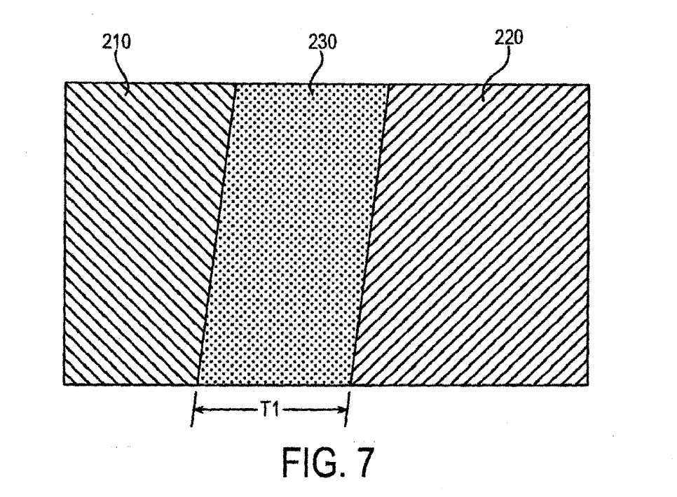

The intent of the first example process is to provide an automated method for creating an injection molded article which is imbedded with an RFID transponder. This is done using a mold which creates an initial lot of bodies. In particular, as shown in FIGS. 6-7, a body is formed of a plastic or other polymeric first material by injecting this material into a form made from the mold cavity 210 and the mold core 220. The body 230 formed has a wall with a first thickness T1.

A wall of the body 230 is then machined so that a wall has part (for example, half) of its original thickness (as before, the thickness dimension is defined for explanatory purposes as being between a first surface and a second surface of the body). For clarity, this thickness, T2, may be referred to as a preassembly thickness. The part may be machined along the entire length and width of the wall, or only a portion of the wall having an area sufficient to contain the transponder. A flow channel from the gate of the mold to this wall is also provided. The flow channel may be inherent with the machined wall opening directly to the gate of the mold, or a separate path may be machined into the body of the article. Preferably, the exterior surface of the wall is machined as this will typically be the surface that is easier to access and easier to provide the second flow of material to.

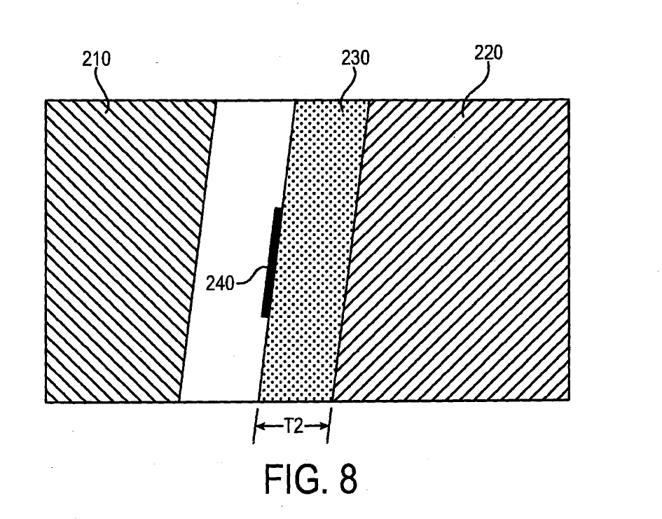

The RFID transponder 240 is then placed on the machined surface of the wall as shown in FIG. 8. The transponder may be temporarily attached to the wall by means of an adhesive or an electric charge.

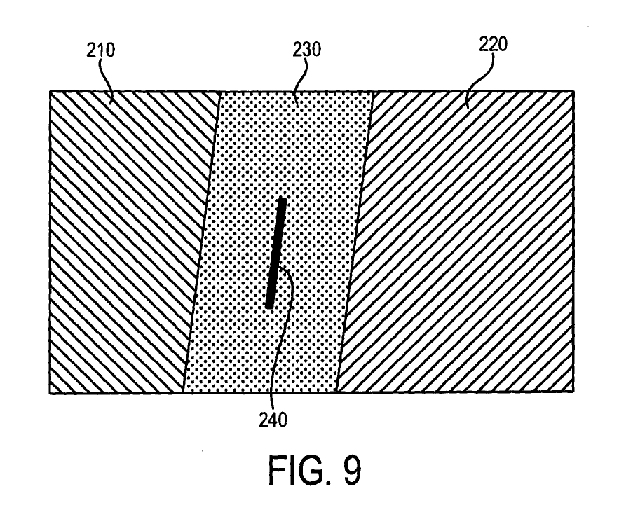

The body may then be heated in an oven to allow the material to expand. After optional expansion, the body is placed on the core 220 of the mold and material is injected into the cavity as shown in FIG. 9. The material used for this overmold may be the same as the original in order to ensure strong adhesion although it need not be. The material flows across the side wall of the part and encapsulates the RFID transponder 240 forming a monolithic wall having a new thickness dimension defined between the first surface and a new second surface, the new thickness being thicker than the preassembly thickness. As described above, this method leaves no witness marks on the surfaces of the wall. The mold 200 then opens and the finished body is ejected off the core.

This method includes injection molding into a first cavity that has a first geometry (shape and size). The second ejection may be into the same cavity or a different cavity having the same geometry.

Referring now to FIGS. 5-7 and 10, the second process may be more useful for mass production and may include cavities run in a press with two independent injection units and an indexing system. There may be two cavities or sets of cavities 210, 210′ (any number of cavities in each set is possible, although two are shown for clarity in FIG. 5), one for the initial molding of the substrate, and a second for overmolding. The first set of cavities would create the initial body by injecting material into an empty cavity as in FIG. 7.

The mold may then open with the substrate parts sticking to the cores. A tagging device such as a robotic arm may then be used to place RFID transponders 240 on a surface (preferably the outside surface) of a wall of the body. In this case, the thinner preassembly thickness is achieved simply by the first injection molding, and requires no machining step to further thin the material.

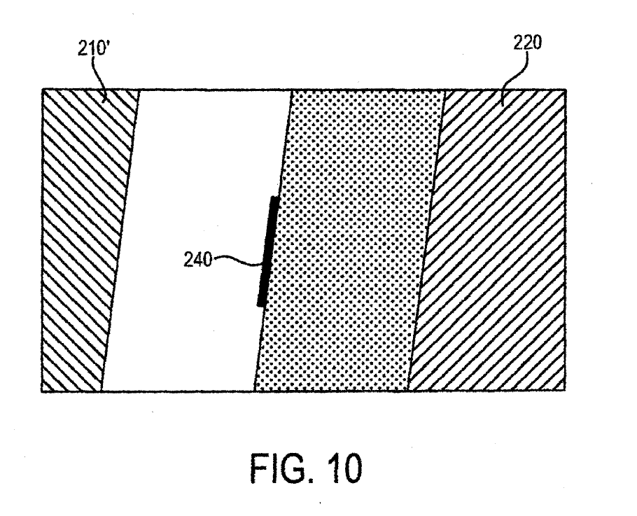

Using a motive device such as a rotary table 260, the cores may be moved relative to the cavities (such as by being rotated to the other side of the mold) and the mold will close with the bodies in the second set of cavities as shown in FIG. 10. The second cavity 210′ has a geometry that is larger than the geometry of the first cavity. In particular, the shape may be the same but with a larger size. For example, the wall thicknesses may all double from the first cavity to the second cavity. Alternatively, the size may be generally the same, but the shape may be such that the wall or a portion of the wall local to the transponder is larger. For example, the first cavity may include an indentation or a single half-thickness wall, while the second cavity does not include this indentation or reduced-size wall. The second cavity 210′ will then be injected with material (preferably the same material that was used in the initial injection). This injection may happen simultaneously with (or at temporally overlapping with) a new set of bodies being created in the first set of cavities. The mold then opens and the overmolded parts are ejected off the cores.

A third process includes dip coating to encapsulate the RFID. In particular, the body of the article to be manufactured may be injection molded in a cavity as described above with respect to the first two methods. After the body is formed, the RFID may be attached to an outer surface of the body, either on a flush outer surface or in a depression made for the RFID by machining or as part of the initial molding process. After the RFID is attached to the body, the RFID is encapsulated by dip coating as described below.

First, the body is immersed in the solution of the coating material. Preferably, this dipping is performed at a constant speed so as to minimize jitter.

Subsequent to immersion, the body may rest in the solution for a predetermined amount of time, depending on the material and application.

After the predetermined amount of time is complete, the body may be withdrawn from the solution. As the body is pulled from the solution, a thin layer of the material deposits itself on the body. The withdrawal is preferably carried out at a constant speed to minimize jitter. The speed of withdrawal will determine the thickness of the coating, and therefore would be selected based on the desired thickness of the coating. In general, a faster withdrawal provides a thicker coating while a quicker withdrawal provides a thinner coating.

After withdrawal, excess liquid may drain from the surface. After (and during) withdrawal, the solvent evaporates from the liquid, forming the thin coating layer.

Optionally, this dip coating process may be iteratively conducted to provide layers of material that may have different properties such as different colors, textures, or hardness. These processes result in a single monolithic body with no intended voids or cavities, and with no witness marks adjacent the transponder on the surfaces of the wall containing the transponder.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A method of making an article having an embedded identifier, the method comprising the steps of:
forming a body of a plastic or other polymeric first material having at least one wall, the wall having a preassembly thickness in a thickness dimension defined between a first surface and a second surface;
placing an identifier on the second surface of the wall; and
encapsulating the identifier by overmolding a plastic or other polymeric second material which may be the same as or different from the first material onto the second surface and the identifier, forming a monolithic wall having a new thickness dimension defined between the first surface and a new second surface, the new thickness being thicker than the preassembly thickness.

2. The method of claim 1, wherein the embedded identifier is a radio frequency identification (RFID) transponder.

3. The method of claim 1, wherein forming the body step includes injection molding the plastic or other polymeric first material.

4. The method of claim 1, wherein forming the body step includes decreasing an initial thickness to the preassembly thickness by machining the second surface of the wall.

5. The method of claim 1, wherein the forming the body step includes injection molding the plastic or other polymeric first material into a first cavity having a cavity geometry, and wherein the encapsulating step includes injection molding the plastic or other polymeric second material into the first cavity or a second cavity having the same cavity geometry as the first cavity.

6. The method of claim 1, further comprising expanding the body by heating before the encapsulating step.

7. The method of claim 1, wherein the new second surface comprises an exterior surface of the article.

8. The method of claim 1, wherein the forming the body step includes injection molding the plastic or other polymeric first material into a first cavity having a cavity geometry, and wherein the encapsulating step includes injection molding the plastic or other polymeric second material into a second cavity having a cavity geometry larger than the cavity geometry of the first cavity.

9. The method of claim 1, wherein the step of encapsulating the identifier by overmolding includes encapsulating the identifier by dip coating the body.

10. An article formed by the method of claim 1.

11. A method of making an article with an embedded identifier, the method comprising the steps of:
closing a mold having a first cavity with a first geometry and a second cavity with a second geometry, the first cavity closing around a first mold core;
injecting into the first cavity a plastic or other polymeric first material to form a first body having at least one wall;
opening the mold to expose the first body;
placing an identifier on a surface of the wall;
repositioning the first body and first core with respect to the mold;
closing the mold with the first cavity around a second core and the second cavity around the first core; and
simultaneously injecting into the first cavity a plastic or other polymeric second material, which may be the same as or different from the first material, to form a second body having at least one wall, and injecting into the second cavity a plastic or other polymeric third material, which may be the same as or different from the first and/or second material, to encapsulate the identifier by overmolding the third material onto the second surface and the identifier,
wherein the second geometry is larger than the first geometry.

12. The method of claim 11, wherein the embedded identifier is a radio frequency identification (RFID) transponder.

13. An article formed by the method of claim 11.

14. A radio frequency identification (RFID)-enabled article, the article comprising:
a body formed of a plastic or other polymeric first material having at least one wall, the wall having a length, a width, and a thickness, and wherein the thickness dimension is smaller than the length and the width and is defined between a first surface and a second surface; and
an RFID transponder embedded 5-95% into the thickness dimension of the wall,
wherein the first and second surfaces of the wall are substantially free from witness marks.

15. The article of claim 11, wherein the first and second surfaces or the wall are free from witness marks.

16. The article of claim 11, wherein the RFID transponder is disposed in the wall and has a length, a width, and a thickness, and wherein the thickness of the RFID transponder is smaller than the length and width of the RFID transponder, and therein the RFID transponder is disposed such that the thickness of the RFID transponder is parallel to the thickness dimension of the wall.

17. The article of claim 11, wherein the RFID transponder is covered by a layer formed of a plastic or other polymeric second material which may the same as or different from the first material.

18. The article of claim 11, wherein the first surface comprises an exterior surface of the article, and the second surface comprises an interior surface of the article.

19. (canceled)

20. The article of claim 11, wherein the wall is a side wall surrounding an inner cavity of the article.

21. (canceled)

22. The article of claim 11, wherein the article is a cryogenic vial.

23. (canceled)

24. (canceled)
